(19) United States
(12) Patent Application Publication
(10) Pub. No.: US 2013/0179267 A1
(43) Pub. Date: Jul. 11, 2013

(54) MOBILE TERMINAL FOR PROVIDING ADVERTISEMENT BASED ON USER CIRCUMSTANCE, AND METHOD THEREOF

(71) Applicant: Samsung Electronics Co., Ltd., Gyeonggi-do (KR)

(72) Inventor: Jeong-Eun LEE, Gyeonggi-do (KR)

(73) Assignee: Samsung Electronics Co., Ltd., Gyeonggi-do (KR)

(21) Appl. No.: 13/739,719

(22) Filed: Jan. 11, 2013

(30) Foreign Application Priority Data
Jan. 11, 2012 (KR) 10-2012-0003539

(51) Int. Cl. G06Q 30/02

(52) U.S. Cl. CPC G06Q 30/0267
USPC 705/14.64

(57) ABSTRACT

A mobile terminal and method for providing an advertisement based on a user circumstance is provided. The mobile terminal includes a user input unit for receiving user-input circumstance information; a storage unit for storing the user-input circumstance information terminal-obtained circumstance information obtained by the mobile terminal, and user profile information; a communication unit for receiving a customized advertisement information configured based on the user input circumstance information, the terminal-obtained circumstance information, the user profile information, and user movement prediction information; a controller for predicting a movement of the user based on the user-input circumstance information, the terminal-obtained circumstance information, and the user profile information, providing the predicted movement of the user, and controlling output of a corresponding advertisement based on the received advertising information; and a display unit for displaying the corresponding advertisement.

### PRIORITY

This application claims priority under 35 U.S.C. §119(a) to a Korean Patent Application filed in the Korean Industrial Property Office on Jan. 11, 2012 and assigned Serial No. 10-2012-0003539, the entire contents of which are incorporated herein by reference.

### BACKGROUND OF THE INVENTION

1. Field of the Invention

The present invention relates generally to a mobile terminal that provides an advertisement and a method thereof, and more particularly, to a mobile terminal that provides an advertisement based on a user circumstance and a method thereof.

2. Description of the Related Art

Mobile terminals, such as smartphones, may be compared to other mass media products, such as television and newspapers that are frequently used by many people. Accordingly, in a manner similar to these other mass products there are many attempts to generate revenue by providing advertisements through the mobile terminals.

One conventional method of providing advertisements through mobile terminals produces coupons, mileage points, discount services, etc., in the form of text or images, and unilaterally transfers the produced text or images. Another such conventional method displays an advertisement in the form of contents on a wireless Internet page where a large amount of mobile terminal traffic exists, so that a user who accesses the wireless Internet page through a mobile terminal recognizes the advertisement through the contents. Yet another such method provides users with information indicating a location of a mobile advertising site in advance of visiting the site, so that the users visit the mobile advertising site through mobile terminals.

However, the method that uses a mobile coupon or a mobile message to attract users to visit stores or other locations may transmit the mobile coupon or the mobile message, regardless of a user's particular circumstances, such as a user's location, schedule, intention to purchase a product or service, etc., and therefore, such methods may provide information that differ from actual needs of particular users. Accordingly, the users may regard mobile coupons or mobile messages received through such methods as spam messages. Also, methods that induce users to visit a separate mobile advertising site or a wireless Internet page may inconveniently require users to remember the advertising site or the users may have difficulty in visiting the advertising site.

### SUMMARY OF THE INVENTION

Accordingly, an aspect of the present invention is to address the above-mentioned problems and to provide at least the advantages described below. Accordingly, an aspect of the present invention is to provide a mobile terminal that provides an advertisement based on a user circumstance such as a user location, a schedule, intention to purchase, a companion, and the like, and a method thereof.

Another aspect of the present invention is to provide a mobile terminal that configures a customized advertisement information by receiving various circumstance information, such as a user location, a schedule, intention to purchase, a companion, and the like, and provides an advertisement appropriate for a circumstance based on the customized advertisement information.

In accordance with an aspect of the present invention, a mobile terminal for providing an advertisement based on a user circumstance is provided. The mobile terminal includes a user input unit for receiving user-input circumstance information; a storage unit for storing the user-input circumstance information terminal-obtained circumstance information obtained by the mobile terminal, and user profile information; a communication unit for receiving a customized advertisement information configured based on the user input circumstance information, the terminal-obtained circumstance information, the user profile information, and user movement prediction information; a controller for predicting a movement of the user based on the user-input circumstance information, the terminal-obtained circumstance information, and the user profile information, providing the predicted movement of the user, and controlling output of a corresponding advertisement based on the received advertising information; and a display unit for displaying the corresponding advertisement.

In accordance with another aspect of the present invention, a method of providing, by a terminal, an advertisement based on a user circumstance is provided. The method includes receiving an input of user-input circumstance information; obtaining terminal-obtained circumstance information, predicting a movement prediction information of a user based on the user-input circumstance information and the terminal-obtained circumstance information; obtaining a customized advertisement information configured based on the user input circumstance information, the terminal-obtained circumstance information, user location shift prediction information, and user profile information; and outputting an advertisement based on the obtained customized advertisement information.

In accordance with another aspect of the present invention, an advertisement server for providing an advertisement to a mobile terminal based on a user circumstance is provided. The advertisement server includes a transceiving unit for receiving, from the mobile terminal, user-input circumstance information, terminal-obtained circumstance information, user location shift prediction information, and user profile information, and for transmitting a customized advertisement information; an advertising information extracting unit for extracting at least one keyword associated with the user input circumstance information, the terminal-obtained circumstance information, the user location shift prediction information, and the user profile information, to receive a search result associated with the at least one keyword, and for extracting advertising information from an advertisement DataBase (DB); a matching unit for matching the extracted advertising information to the user profile information, the user-input circumstance information, the terminal-obtained circumstance information, and the user location shift prediction information, through use of advertisement matching information stored in an advertisement matching DB, and for obtaining the advertising information according to the matching; and a customized advertisement information configuring unit for configuring the customized advertisement information by arranging the obtained advertising information based on at least one of a circumstance, a time, and movement of a user.

In accordance with another aspect of the present invention, a method of providing an advertisement to a mobile terminal based on a user circumstance is provided. The method includes receiving, from the mobile terminal, user-input circumstance information, terminal-obtained circumstance information, user location shift prediction information, and user profile information; extracting at least one keyword associated with the user-input circumstance information, the terminal-obtained circumstance information, the user location shift prediction information, and the user profile information, receiving a search result associated with the at least one keyword, and extracting advertising information from an advertisement DataBase (DB); matching the extracted advertising information to the user profile information, the user input circumstance information, the terminal-obtained circumstance information, and the user location shift prediction information, and obtaining matching advertising information according to the matching; configuring the advertising scenario by arranging the obtained advertising information, based on at least one of a circumstance, a time, movement of a user; and transmitting the configured advertising scenario.

In accordance with another aspect of the present invention, a non-transitory computer-readable storage medium that stores a program implemented in a mobile terminal for performing a method for providing an advertisement based on a user circumstance is provided. The method includes receiving an input of user-input circumstance information; obtaining terminal-obtained circumstance information; predicting movement prediction information of a user based on the user-input circumstance information and the terminal-obtained circumstance information; obtaining an advertising scenario configured based on the user-input circumstance information, the terminal-obtained circumstance information, the user location shift prediction information, and user profile information; and outputting an advertisement based on the obtained advertising scenario.

### BRIEF DESCRIPTION OF THE DRAWINGS

The above and other aspects, features and advantages of the present invention will be more apparent from the following detailed description taken in conjunction with the accompanying drawings, in which:

FIG. 1 is a diagram illustrating a system for providing an advertisement based on a user circumstance according to an embodiment of the present invention;

FIGS. 2A and 2B are a flowchart illustrating a process of providing an advertising scenario based on a user circumstance according to an embodiment of the present invention;

FIG. 3 is a diagram illustrating configurations of an advertisement server, an advertisement database (DB), and an advertisement matching DB according to an embodiment of the present invention;

FIG. 4 is a diagram illustrating a configuration of a mobile terminal according to an embodiment of the present invention;

FIG. 5 is a flowchart illustrating a method of providing an advertisement based on a user circumstance according to an embodiment of the present invention;

FIG. 6 is a diagram illustrating an example of a screen for inputting user circumstance information according to an embodiment of the present invention; and

FIG. 7 is a diagram illustrating a screen that displays an advertisement output based on an advertising scenario according to an embodiment of the present invention.

### DETAILED DESCRIPTION OF EMBODIMENTS OF THE PRESENT INVENTION

Hereinafter, embodiments of the present invention are described with reference to the accompanying drawings. In the following description, detailed descriptions of known functions and configurations incorporated herein may be omitted when such a description may obscure the subject matter of the present invention. Further, various specific definitions of certain terms in the following description are provided only to help general understanding of the present invention, and it is apparent to those skilled in the art that embodiments of the present invention are not necessarily limited to embodiments conforming to such definitions.

According to an embodiment of the present invention, a mobile terminal that configures or is provided with an advertising scenario based on user input circumstance information input by a user and terminal-obtained circumstance information obtained by a terminal, and outputs an advertisement appropriate for a user circumstance based on the advertising scenario, as well as a method for performing the same operations, are provided.

The user input circumstance information may be input by the user, and includes information such as a schedule of the user, an area to be visited by the user, a wish list, a residential area, item-to-be-purchased information, purchase history information, companion information, interest information, etc. The terminal-obtained circumstance information, which may be obtained by the terminal, includes information such as time information, location information, weather information, season information, etc. When the mobile terminal configures the advertising scenario, the mobile terminal may receive advertising information from an advertisement server in order to configure the advertising scenario based on user circumstance information. However, when the mobile terminal is provided with the advertising scenario, the mobile terminal may provide user circumstance information to the advertisement server and may receive the advertising scenario configured by the advertisement server based on the user circumstance information. According to embodiments of the present invention, the advertising scenario is customized advertisement information. The customized advertisement information may be configured by matching advertisements extracted based on the user input circumstance information and the terminal-obtained circumstance information with respect to a circumstance, a time zone, and location shift prediction information, and arranging matching advertisements and thus, the matching advertisements may be provided based on a circumstance of the user, a time zone, or a location.

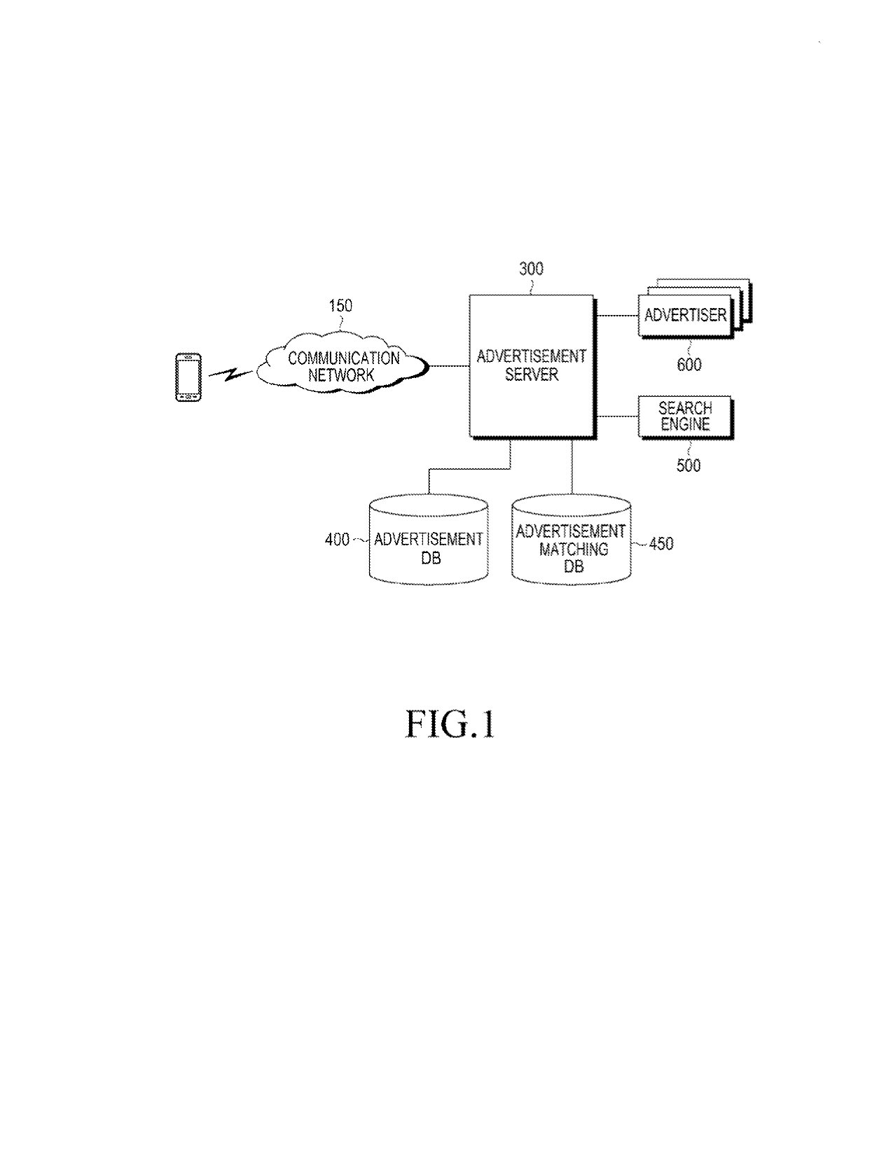

FIG. 1 illustrates a system for providing an advertisement based on a user circumstance according to an embodiment of the present invention.

Referring to FIG. 1, a mobile terminal 100 receives, from a user, an input of various circumstance information including a schedule of the user, an area to visit, a wish list, a residential area, item-to-be-purchased information, purchase history information, companion information, interest information, etc., stores the various input circumstance information, and obtains terminal-obtained circumstance information such as time information, location information, weather information, season information, etc. The mobile terminal 100 may predict a location shift of the user (i.e., predict a user's future movements) based on the user input circumstance information and the terminal-obtained circumstance information. The mobile terminal 100 may configure an advertising scenario or may be provided with an advertising scenario from an advertisement server 300, through use of the user input circumstance information, the terminal-obtained circumstance information, user location shift prediction information, and user profile information. The mobile terminal 100 outputs an advertisement corresponding to user circumstance information, a time zone, and/or a location, based on the advertising scenario.

The advertisement server 300 receives advertising information from at least one advertiser 600, and stores the received advertising information in an advertisement DataBase (DB) 400. When the advertisement server 300 configures and provides the advertising scenario, the advertisement server 300 receives, from the mobile terminal 100 via a communication network 150, the user profile information, the user input circumstance information and the terminal-obtained circumstance information, and the user location shift prediction information. The advertisement server 300 extracts a search word corresponding to the user profile information, the user input circumstance information and the terminal-obtained circumstance information, and the user location shift prediction information, from among advertising information stored in the advertisement DB 400, and receives an advertisement search result associated with the search word from a search engine 500. The advertisement server 300 extracts an advertisement from the advertisement DB 400 based on the advertisement search result, and performs matching with respect to the extracted advertising information based on advertisement matching information stored in an advertisement matching DB 450. In the present example, the advertisement matching DB 450 stores advertisement matching information, including synonym dictionary and category and keyword matching information, time zone, language, and country matching information, and distance information, and the advertisement server 300 matches the extracted advertising information to the synonym dictionary and category and keyword matching information, the time zone, language, and country matching information, and the distance information stored in the advertisement matching DB 450. The advertisement server 300 also configures an advertising scenario by arranging matching advertisements based on a circumstance of the user, a time zone, or an order of a location shift, and provides the advertising scenario to the mobile terminal 100 via the communication network 150.

When the advertising scenario is configured by the mobile terminal 100, the advertisement server 300 provides the mobile terminal 100 with the advertising information extracted based on the user profile information, the user input circumstance information and the terminal-obtained circumstance information, and the user location shift prediction information so that the mobile terminal 100 configures the advertising scenario.

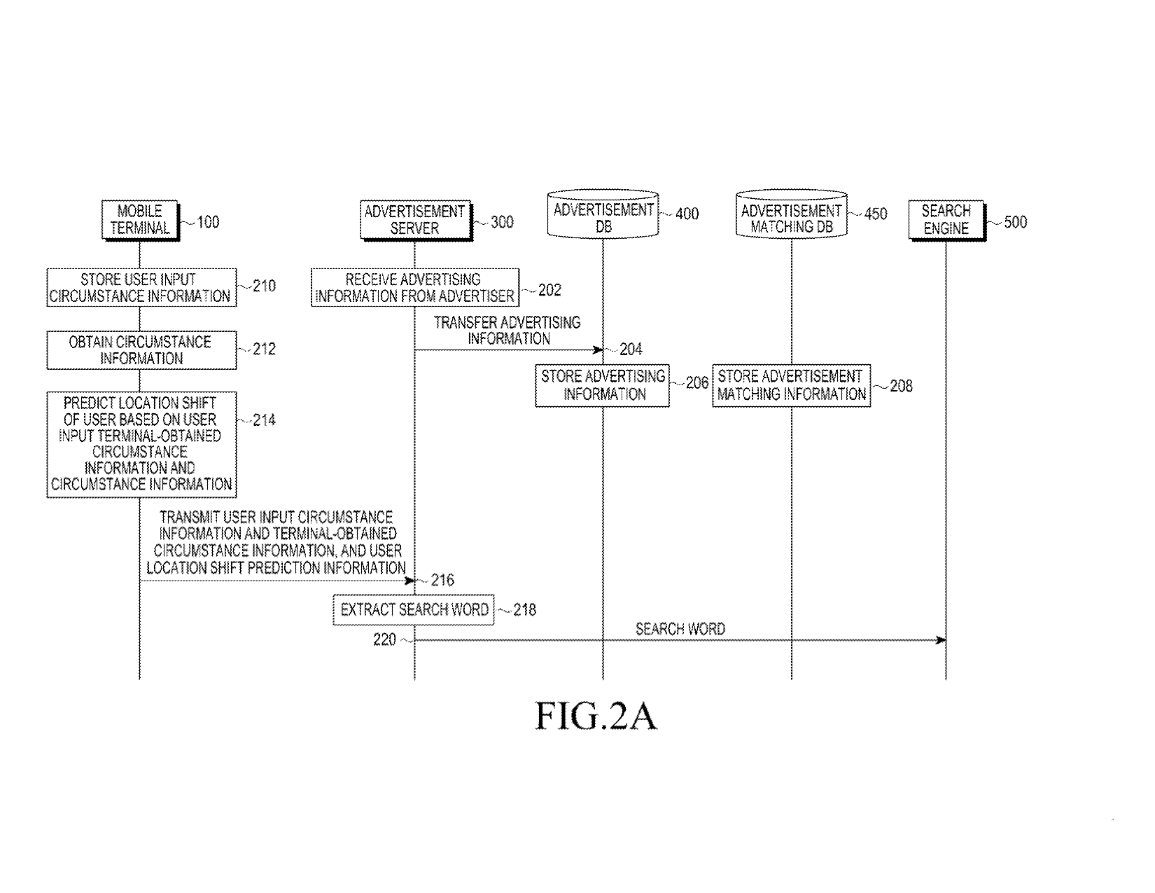

FIGS. 2A and 2B illustrate a process of providing an advertisement based on a user circumstance in an advertisement providing system according to an embodiment of the present invention.

Referring to FIG. 2A, the advertisement server 300 receives advertising information from at least one advertiser in step 202, and transfers the received advertising information to the advertisement DB 400, in step 204. The advertisement DB 400 stores advertising information, in step 206. In the present example, the advertising information includes advertising data corresponding to at least one advertisement, including data such as a video, a picture, a text, a website address, etc., to express contents of each advertisement. The advertisement information may also include a category for each advertisement, keywords for each advertisement, location (distance) information associated with each advertisement, etc. The advertisement matching DB 450 stores advertisement matching information, in step 208. The advertisement matching information includes information such as a synonym dictionary and category and keyword matching information, time zone, language, and country matching information, and location (distance) information. The advertisement matching information may also include previous advertising scenario information.

The mobile terminal 100 receives, from the user, an input of user input circumstance information, in step 210. The user input circumstance information may correspond to current and/or future user circumstances, and may include a schedule of the user, an area to be visited by the user, a wish list, a residential area, item-to-be-purchased information, purchase history information, companion information, interest information, etc. The mobile terminal 100 may additionally receive and store any information that used to predict current and/or future user circumstances.

The mobile terminal 100 obtains circumstance information determined by the terminal 100, in step 212. In the present example, the circumstance information determined by the terminal 100 corresponds to terminal-obtained circumstance information determined by the terminal 100 itself. This terminal-obtained circumstance information includes information such as time information, location information, weather information, season information, etc.

After the user input circumstance information is input and the terminal-obtained circumstance information are obtained, the mobile terminal 100 predicts a location shift of a user based on the obtained information, in step 214. The mobile terminal 100 transmits, to the advertisement server 300, the user input circumstance information and the terminal-obtained circumstance information, user location shift prediction information, and user profile information, in step 216. In the present example, the user profile information includes user basic information to be used to identify the user and/or the mobile terminal 100, such as personal information of the user, a mobile terminal IDentification (ID), etc.

When the user input circumstance information and the terminal-obtained circumstance information, the user location shift prediction information, and the user profile information are received from the mobile terminal 100, the advertisement server 300 extracts a search word from information received from the mobile terminal 100, in step 218. In the present example, the advertisement server 300 extracts, as the search word, a keyword included in the information, such as a word corresponding to the schedule, the area to visit, the wish list, the residential area, the item-to-be-purchased information, the purchase history information, the companion information, the interest information, etc., that are included in the user input circumstance information, and a keyword included in the terminal-obtained circumstance information. When the search word is extracted, the advertisement server 300 sends, to the search engine 500, a request to perform searching associated with the search word, in step 220.

Referring now to FIG. 2B, the search engine 500 performs searching according to the search word in step 222, and provides a search result to the advertisement server 300, in step 224. The search result includes various information retrieved through use of the keyword included in the user input circumstance information, such as the schedule, the area to visit, the wish list, the residential area, the item-to-be-purchased information, the purchase history information, the companion information, the interest information, etc., as well as the time information, the location information, the weather information, the season information, etc.

The advertisement server 300 extracts advertising information from the advertisement DB 400 according to the retrieved information, in step 226. For example, keywords included in the user input circumstance information and the terminal-obtained circumstance information are “Itaewon” (i.e., a location) and “sugar face pack” (i.e., an item-to-be-purchased), the search engine 500 may perform searching associated with “Itaewon” and “sugar face pack”. When ‘Itaewon SKIN FOOD’ corresponding to information associated with a store that is located in Itaewon and sells a sugar face pack is retrieved, the advertisement server 300 extracts advertising information associated with the “Itaewon SKIN FOOD” from the advertisement DB 400. For example, the advertising information may correspond to an advertisement that indicating that Itaewon SKIN FOOD is having a 30% off opening sale, etc. In the present example, information associated with other stores that sell a sugar face pack, such as an Itaewon cosmetics store, an Itaewon convenience store, etc., may be retrieved along with “Itaewon SKIN FOOD”, and the advertisement server 300 extracts advertising information associated with all of the results retrieved from the advertisement DB 400.

In step 228, after extracting the advertising information, the advertisement server 300 matches the advertising information with respect to the user input circumstance information and the terminal-obtained circumstance information through use of advertisement matching information stored in the advertisement matching DB 450, performs filtering to obtain advertising information that matches the user input circumstance and the terminal-obtained circumstance information, and configures a corresponding advertising scenario. As described above, the advertisement matching DB 450 obtains advertising information that matches the user input circumstance information, the terminal-obtained circumstance information, and the user location shift prediction information. For example, the obtained advertisement information may correspond to an area within a radius of 2 kilometers(km) from a predicted user location.

The advertisement server 300 configures the advertising scenario by arranging the advertising information obtained through filtering, based on a circumstance, a time zone, or an order of a location shift of the user.

After configuring the advertising scenario, the advertisement server 300 provides the advertising scenario to the mobile terminal 100 in operation 230. The mobile terminal 100 receives the advertising scenario, and outputs an advertisement based on the advertising scenario in operation 232.

When the advertisement output based on the advertising scenario is used by the user 234, the mobile terminal 100 transfers advertisement usage information to the advertisement server 300. Accordingly, the advertisement server 300 stores the advertisement usage information in step 236, and manages advertisement usage information for each user. In the present example, the advertisement usage information managed for each user is utilized when an advertising scenario is subsequently configured.

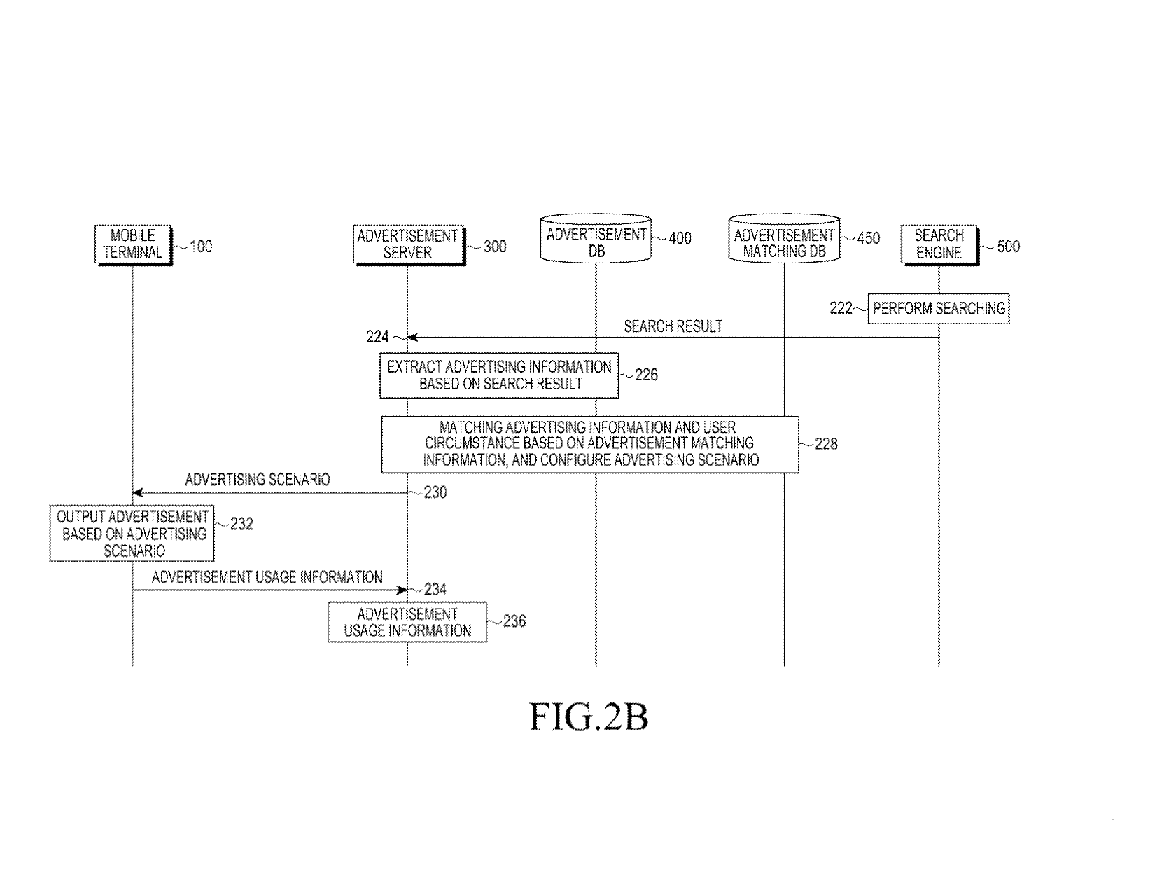

Hereinafter, configurations of the mobile terminal 100, the advertisement server 300, the advertisement DB 400, and the advertisement matching DB 450 that are used for providing an advertisement based on a user circumstance, are described in detail with reference to FIG. 3.

FIG. 3 illustrates configurations of an advertisement server, an advertisement DB, and an advertisement matching DB according to an embodiment of the present invention.

Referring to FIG. 3, the advertisement DB 400 stores advertising information, and the advertising information includes a category for each advertisement 402, a keyword for each advertisement 404, location and distance information for each advertisement, and advertising data 408. The advertising data 408 is received from at least one advertiser 600, and includes at least one advertisement in the form of a video, a picture, a text, a website address, etc. The category for each advertisement 402 includes category information for each advertisement included in the advertising data 408. The keyword for each advertisement 404 includes keyword information for each advertisement included in the advertising data 408. The location and distance information for each advertisement 406 includes location information and distance information associated with each of the advertisements.

The advertisement matching DB 450 includes DBs for storing information to be used for extracting an advertisement that matches user input circumstance information and terminal-obtained circumstance information from advertising information extracted based on information retrieved through use of search words associated with the user input circumstance information and the terminal-obtained circumstance information. For example, the advertisement matching DB 450 includes a distance information DB 452, a matching information DB 454, a synonym dictionary and category and keyword matching DB 456, and a time zone, language, and country matching DB 458. The distance information DB 452 stores distance information between user locations predicted based on the user input circumstance information and the terminal-obtained circumstance information. The matching information DB 454 stores previous circumstance information input by the user, and the synonym dictionary and category and keyword matching DB 456 includes synonym dictionary and category information and keyword information. The time zone, language, and country matching DB 458 include time zone information, language information, and country information.

The advertisement server 300 configures an advertising scenario through use of the information stored in the advertisement DB 400 and the advertisement matching DB 450. The advertisement server 300 includes a log information managing unit 310, an advertising information extracting unit 320, a matching unit 330, an advertising scenario configuring unit 340, and a transceiving unit 350.

The log information managing unit 310 includes a target information unit 311, a log manager 312, and a log information monitoring unit 313. The target information unit 311 stores target information for targeting for an advertisement. For example, when an application corresponding to a cosmetics company is downloaded, a user who downloads the app becomes a target of a cosmetics advertisement, and the target information unit 311 stores target information associated with various the user. The log manager 312 may manage log information of the user. The log information may include information indicating whether the user uses the mobile terminal 100, telephone conversation information of the user, information associated with apps that are downloaded or used by the user, etc. The log information is utilized for configuring the target information. The monitoring unit 313 monitors the log information of the user.

The advertising information extracting unit 320 extracts a search word corresponding to the user profile information, the user input circumstance information and the terminal-obtained circumstance information, and the user location shift prediction information that are received by the transceiving unit 350 from the mobile terminal 100, and transmits the search word to the search engine 500, and receives search result information associated with the search word. The advertising information extracting unit 320 also extracts an advertisement from the advertisement DB 400 based on the search result, and provides the extracted advertisement to the matching unit 330.

The matching unit 330 matches the advertising information extracted by the advertising information extracting unit 320 to the user profile information, the user input circumstance information and the terminal-obtained circumstance information, and the user location shift prediction information, through use of the advertisement matching information stored in the advertisement matching DB 450, and performs filtering to obtain matching advertising information. Accordingly, the matching unit 330 obtains advertising information that matches the user profile information, the user input circumstance information, the terminal-obtained circumstance information, and the user location shift prediction information. For example, the advertisement information may correspond to an area within a radius of 2 km from a predicted user location.

The advertising scenario configuring unit 340 configures an advertising scenario by arranging the advertising information that matches the user profile information, the user input circumstance information and the terminal-obtained circumstance information, and the user location shift prediction information, based on a circumstance of the user, a time zone, or an order of a location shift of the user.

The transceiving unit 450 receives, from the user terminal 100, the user profile information, the user input circumstance information and the terminal-obtained circumstance information, and the user location shift prediction information, and transmits the advertising scenario configured by the advertising scenario configuring unit 340 to the mobile terminal 100.

The mobile terminal 100 receives the advertising scenario from the advertisement server 300, and outputs an advertisement based on the advertising scenario.

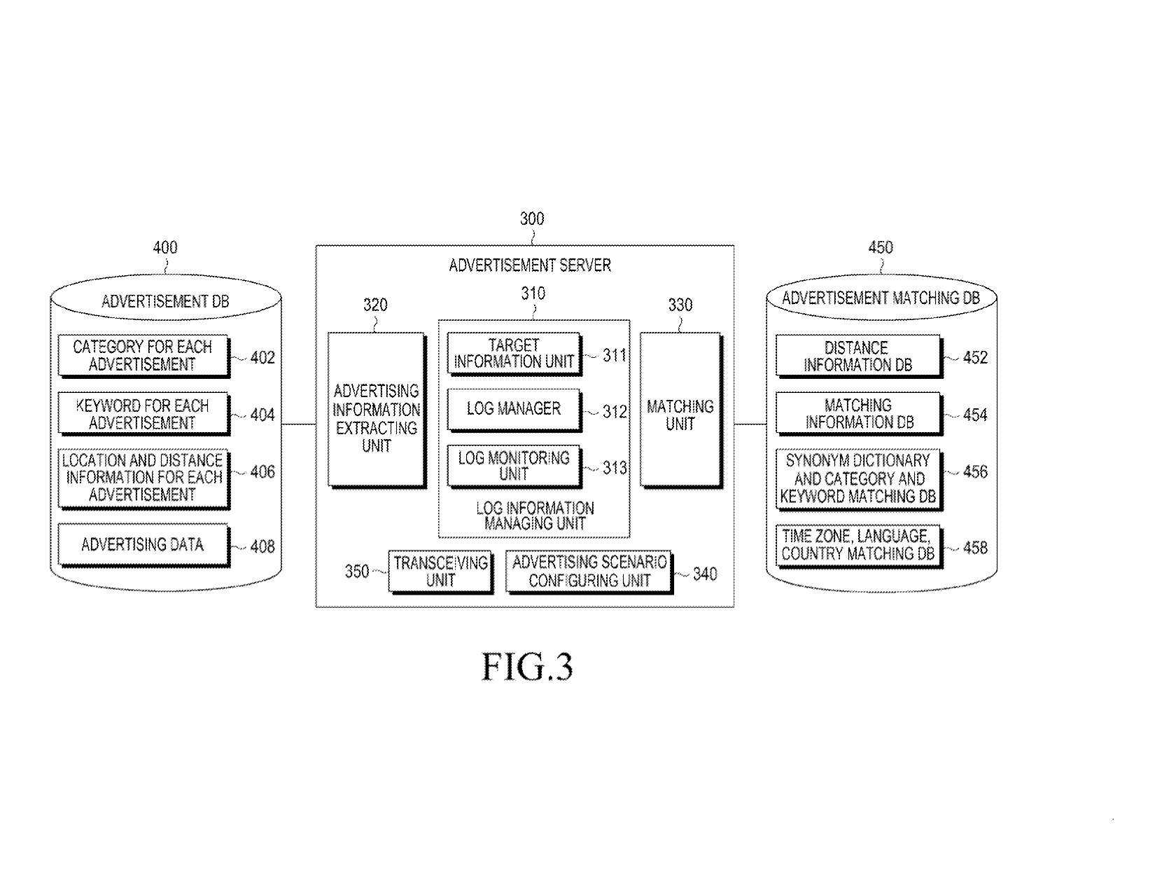

Hereinafter, the configuration of the mobile terminal 100 is described in detail with reference to FIG. 4.

FIG. 4 illustrates a configuration of a mobile terminal according to an embodiment of the present invention.

Referring to FIG. 4, the mobile terminal 100 includes a user input unit 110, a controller 120, a communication unit 130, a storage unit 140, an advertising scenario processing unit 150, and a display unit 160.

The user input unit 110 may be configured as a keypad, a touch screen, etc., which is formed of a combination of a plurality of keys for inputting various numbers, characters, codes, various user commands, etc. The user input unit 110 receives an input of user input circumstance information from the user, and transfers the user input circumstance information to the controller 120.

The communication unit 130 communicates under a control of the controller 120, and contents of the communication and a communication method may vary based on an application executed in the mobile terminal 100 or a function of the mobile terminal 100. The communication unit 130 transmits, to the advertisement server 300, the user input circumstance information input by the user, the terminal-obtained circumstance information, user profile information, and user location shift prediction information. The communication unit 130 receives advertising scenarios from the advertisement server 300.

The storage unit 140 may be configured as a non-volatile memory embodied as a flash memory, hard disk, etc., and may store data or programs required for operations of the mobile terminal 100. In particular, the storage unit 140 includes a DB manager 142, a user input circumstance information DB 144, a terminal-obtained circumstance information DB 146, and a user profile DB 140. The DB manager 140 manages inputs and outputs of the user input circumstance information DB 144, the terminal-obtained circumstance information DB 146, and the user profile DB 140. The user input circumstance information DB 144 stores circumstance information input by the user. The circumstance information input by the user includes information such as a schedule of the user, an area to be visited by the user, a wish list, a residential area, item-to-be-purchased information, purchase history information, companion information, interest information, etc. The terminal-obtained circumstance information DB 146 stores information obtained by the mobile terminal 100, and the terminal-obtained circumstance information includes location information, time information, weather information, season information, etc. The user profile DB 140 stores the user profile information, and the user profile information includes user basic information for identifying the user or the mobile terminal 100 such as personal information of the user, a mobile terminal ID, etc.

The controller 120 performs controls general operations of the mobile terminal 100. The controller 120 also controls storage of the user input circumstance information input through the user input unit 110, in the user input circumstance information DB 144. The controller 120 also controls storage of the terminal-obtained circumstance information obtained by a time determining unit 122, a location determining unit 124, a terminal usage information determining unit 126, and an application download information determining unit 128 in the terminal-obtained circumstance information DB 146.

In present example, the time determining unit 122 determines time information based on information such as that provided by a timer. The location determining unit 124 determines location information based on information such as Global Positioning System (GPS) information. The terminal usage information determining unit 126 determines terminal usage information associated with the user. The terminal usage information includes information such as a telephone conversation history of the user, a text message transmission history, the terminal power on/off history, etc. The application download information determining unit 128 determines whether an application is downloaded or whether the downloaded application is used. The controller 120 extracts the personal information of the user or ID information of the mobile terminal 100 stored in the user profile DB 148 through use of a user profile extracting unit 129.

The controller 120 predicts a user location based on the user input circumstance information and the terminal-obtained circumstance information when the user input circumstance information is input through the user input unit 110. The controller 120 the communication unit 130 to transmit, to the advertisement server 300, circumstance information including the user input circumstance information and the terminal-obtained circumstance information, the predicted location information, and the user profile information. When the advertising scenario is received from the advertisement server 300 through the communication unit 130, the controller 120 processes the received advertising scenario through the advertising scenario processing unit 150, and controls display of an advertisement based upon the advertising scenario on the display unit 160.

The advertising scenario processing unit 150 analyzes the advertising scenario, determines whether a user circumstance corresponds to a location and a time associated with the advertising scenario, and provides an advertisement corresponding to the location and the time associated with the advertising scenario. When the terminal 100 configures the advertising scenario, the advertisement processing unit 150 configures the advertising scenario through use of the circumstance information including the user input circumstance information and the terminal-obtained circumstance information, the predicated location information, and the user profile information.

The display unit 160 may be configured as a Liquid Crystal Display (LCD), an Organic Electro-Luminescence Display (OELD), or other such display, and displays a screen that indicates an operation or a state of the mobile terminal 100 under the control of the controller 120. In particular, the display unit 160 displays a screen for inputting user circumstance information and displays a screen for an advertisement based on the advertising scenario.

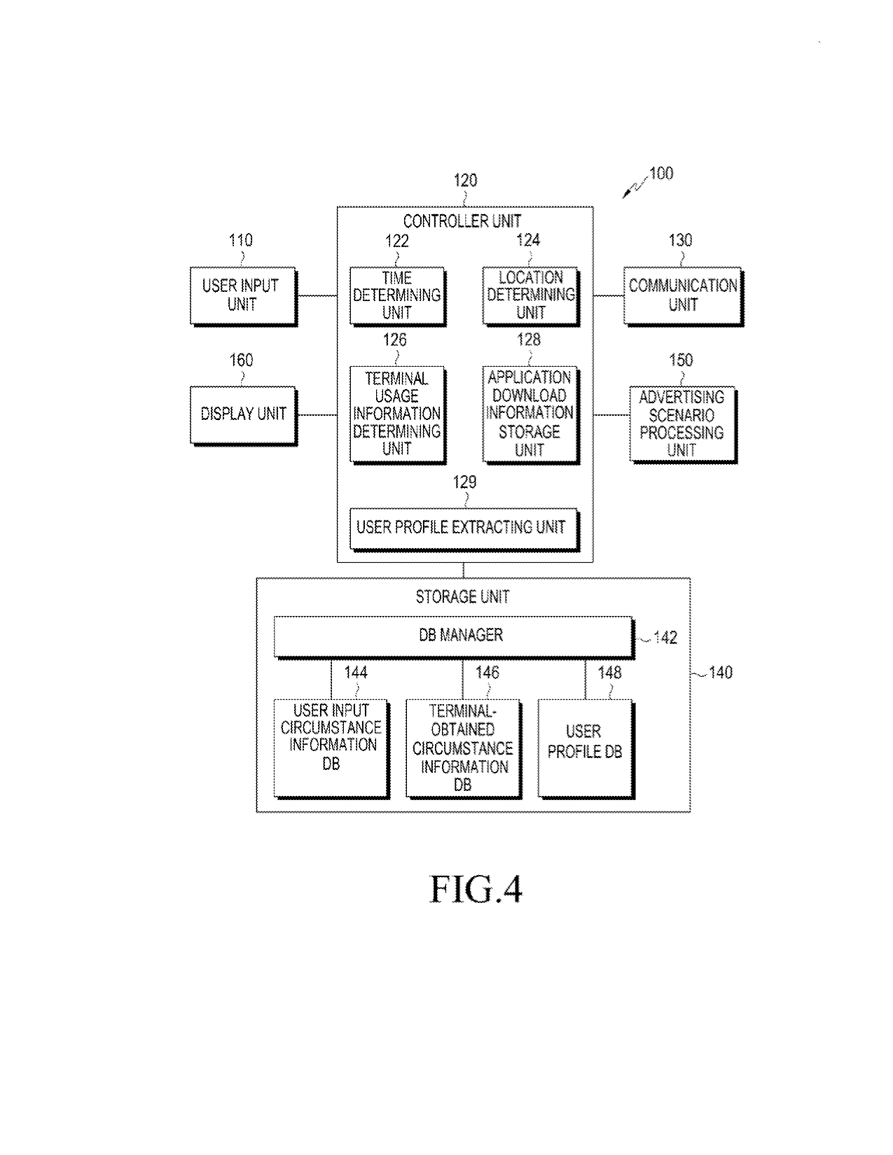

Hereinafter, the operation of the mobile terminal 100 is described in detail with reference to FIGS. 5-7. FIG. 5 illustrates the operation of a mobile terminal according to an embodiment of the present invention.

Referring to FIG. 5, when user input circumstance information is input through a user input unit 110, the mobile terminal 100 stores the user input circumstance information, in step 512. The user input circumstance information includes information such as a schedule of a user, an area to be visited by the user, a wish list, a residential area, item-to-be-purchased information, purchase history information, companion information, interest information, etc.

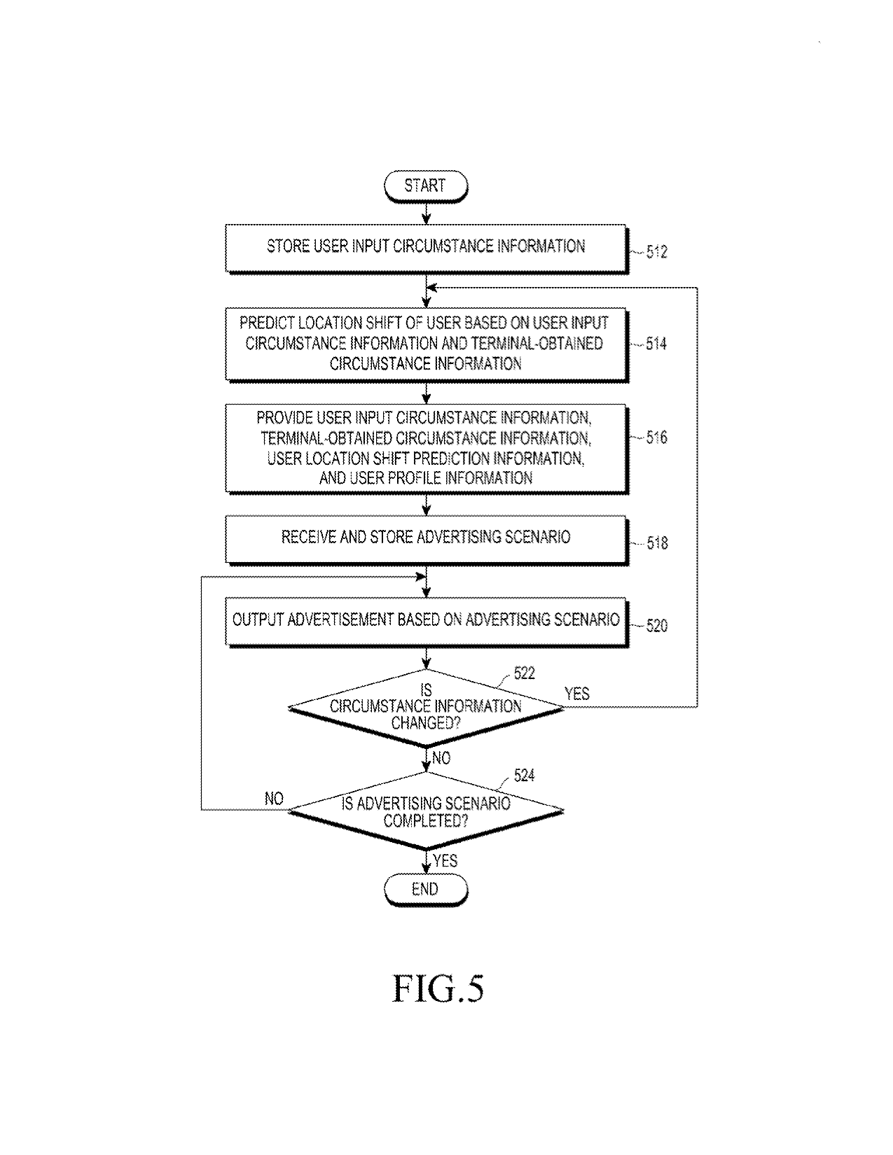

FIG. 6 illustrates an example of a screen for inputting user circumstance information according to an embodiment of the present invention.

Referring to FIG. 6, a user selects a date 62, and inputs a schedule including time information and an area to visit. Although not illustrated, the user may also input item-to-be-purchased information and price information of an item to be purchased. The screen for inputting the user circumstance information may be displayed in various other configurations in accordance with embodiments of the present invention.

The mobile terminal 100 predicts a location shift of the user through use of the user input circumstance information and terminal-obtained circumstance information, in step 514. For example, the terminal-obtained circumstance information may correspond to time information, location information, weather information, season information, etc. For example, the mobile terminal 100 predicts an event to be performed by the user for each time zone, and a location where the event is to be performed.

When prediction with respect to the movement of the user is completed, the mobile terminal 100 provides the advertisement server 300 with user profile information that is stored in advance, the user input circumstance information and the terminal-obtained circumstance information, and user movement prediction information. In the present example, the advertisement server 300 configures an advertising scenario through use of the user profile information, the user input circumstance information and the terminal-obtained circumstance information, and the user location shift prediction information. Accordingly, the advertisement server 300 extracts, as a search word, a keyword included in the user profile information, the user input circumstance information and the terminal-obtained circumstance information, and the user location shift prediction information, and may be provided with a search result associated with the search word from the search engine 500. Also, the advertisement server 300 may extract advertising information from the advertisement DB 400 through use of the search result. For example, when the keywords included in the circumstance information are “Hangang” (i.e., a location) and “walk” (i.e., a scheduled activity), the search engine 500 performs search associated with “Hangang” and “walk”. As a result of the searching, various information including the keywords “Hangang” and “walk”, such as “Hangang Banpo area kite-flying contest,” “Hangang bike course,” “Hangang walking path chicken delivery service,” “please don't take a walk in the Hangang park,” etc., may be retrieved. Based on the search results, the advertisement server 300 extracts advertising information corresponding to the search results from the advertisement DB 400. After extracting the advertising information, the advertisement server 300 matches the advertising information to the user input circumstance information and the terminal-obtained circumstance information, according to the advertisement matching information stored in the advertisement matching DB 450, and obtains advertising information that matches the user input circumstance information and the terminal-obtained circumstance information. The advertisement server 300 configures an advertising scenario by arranging the obtained advertising information based on an event to be performed by the user for each time zone or user location shift prediction information, and provides the advertising scenario to the mobile terminal 100.

Accordingly, the mobile terminal 100 receives and stores the advertising scenario in operation 518. The mobile terminal 100 outputs an advertisement based on the advertising scenario, in step 520. For example, the mobile terminal 100 determines whether a user circumstance corresponds to a circumstance, a location, or a time associated with the advertising scenario, and displays an advertisement corresponding to the location and time associated with the advertising scenario.

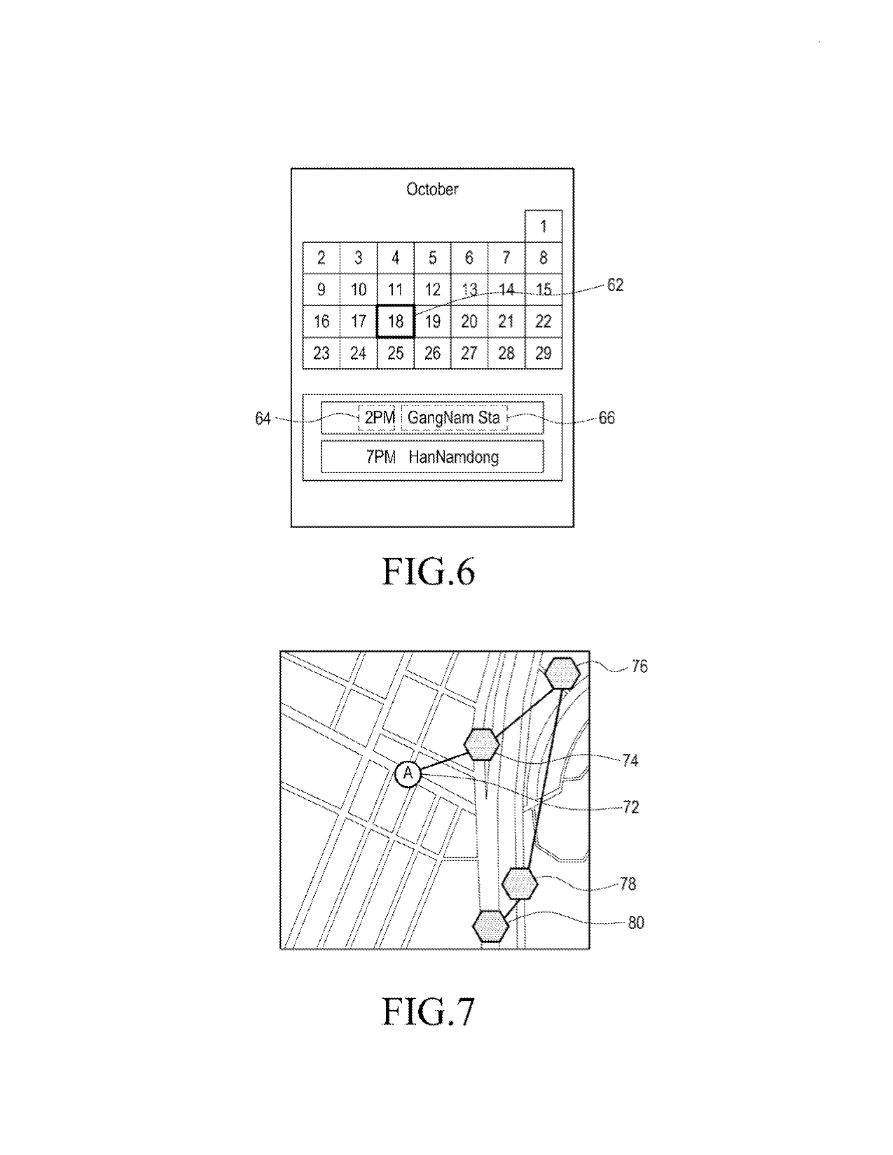

FIG. 7 illustrates an example of a screen that displays an advertisement output based on an advertising scenario according to an embodiment of the present invention.

Referring to FIG. 7, the advertising scenario may be displayed along with a location of a user, over time. A point 72 indicates a current location of the user, and points 72 through 80 indicate points corresponding to a sequence of locations of the user over time. According to an embodiment of the present invention, the mobile terminal 100 displays advertisements that correspond to areas within a predetermined distance from the locations of the points 72 through 80. In addition to, or as an alternative to this scheme, the advertisements may be sequentially provided in a text format, an image, a moving picture, etc., based on the advertising scenario, in accordance with embodiments of the present invention.

After outputting an advertisement based on the advertising scenario, the mobile terminal 100 determines whether the user input circumstance information input by the user or the terminal-obtained circumstance information is changed, in step 522. When new circumstance information is input by the user, the mobile terminal 100 determines that the user input circumstance information has been changed. Also, when location information, time information, weather information, or season information is out of a predetermined value, the mobile terminal 100 determines that the terminal-obtained circumstance information has been changed.

When the user input circumstance information or the terminal-obtained circumstance information is changed, the mobile terminal 100 returns to step 514 so as to repeat step 514 through 520 based on the changed user input circumstance information or the changed terminal-obtained circumstance information.

When the user input circumstance information or the terminal-obtained circumstance information is not changed, the mobile terminal 100 proceeds from step 522 to step 524 and determines whether the advertising scenario is completed. When the advertising scenario is not completed, the mobile terminal 100 returns to step 520, and iteratively performs steps 520 through 524 until the advertising scenario is completed.

As explained in the foregoing description, when a user inputs a circumstance, such as “having a cup of coffee in a place from which Banpo Hangang is visible” through use of a terminal that is provided with an advertisement based on user circumstance information such as “coffee” and “Banpo”, according to an embodiment of the present invention, the user is provided with advertising information such as a coupon for Americano coffee in the Banpo branch of “Coffee Beans”, or other such offers. Also, when the user inputs circumstances information such as “ice flakes snack”, the user is provided with advertising information, such as “Milktop ice flakes in Apgujeong Hyundai department store” through use of the user-provided circumstance information, as well as circumstance information such as ““Apgujeong” obtained by the terminal. Also, even when circumstance information is not input by the user, the user is provided with advertising information, such as “Sinsa-dong Garosu-gil School Food launching new menu” through use of the terminal-obtained circumstance information, based upon a determined location of the user, such as “Sinsa-dong Garosu-gil”.

Accordingly, the embodiments of the present invention provide advertisements appropriate for a user's circumstance, based on an advertising scenario that is previously configured through use of circumstance information such as a schedule of a user, an area to be visited by the user, a wish list, a residential area, item-to-be-purchased information, purchase history information, companion information, interest information, etc., and terminal-obtained circumstance information such as time information, location information, weather information, season information, etc. Therefore, the provided advertisements may maximize effectiveness with respect to the user. Also, the user is provided with advertisements appropriate for a user's particular circumstances, and thereby enabling a user to purchase a desired product or visit a desired place. A method of providing an advertisement based on a user circumstance according to embodiments of the present invention may be produced as a program and may be stored in a storage medium. A mobile terminal may download or install such a program in order to provide a user with advertisements appropriate for a user's particular circumstances.

The above-described embodiments of the present invention may be embodied as hardware, software or a combination of hardware and software. Software may be stored in a volatile or non-volatile storage device such as Read Only Memory (ROM) and Random Access Memory (RAM) (including fixed, erasable, or rewritable memory) or a storage medium that is capable of performing optical or magnetic recording and machine-reading such as a Compact Disc (CD), Digital Versatile Disc (DVD), optical disc, magnetic tape, etc. A memory that may be included in a mobile terminal equipped with a multimedia content player may be an example of machine-readable storage media that are suitable for storing a program including instructions to implement the embodiments, or programs. Therefore, embodiments of the present invention may include a program including a code to implement an apparatus or a method claimed in a claim of the specification, and a machine-readable storage medium including the program, for example, a computer-readable storage medium. The program may be transferred electronically through a medium such as a communication signal transferred through a wired or wireless connection, and the invention may appropriately include an equivalent medium.

While embodiments of the present invention have been shown and described with reference to certain embodiments thereof, it will be understood by those skilled in the art that various changes in form and details may be made therein without departing from the spirit and scope of the present invention as defined by the appended claims. For example, although the above-described embodiments of the present invention refer to user input circumstance information including a schedule of a user, an area to be visited, a wish list, a residential area, an item-to-be-purchased information, purchase history information, companion information, interest information, etc., and terminal-obtained circumstance information including time information, location information, weather information, season information, etc., any other such information that represents a user's circumstances may be included as circumstance information in accordance with embodiments of the present invention. Similarly, although the above-described embodiments of the present invention refer to an advertising scenario configured by an advertisement server, the advertising scenario may also be configured by a mobile terminal in accordance with embodiments of the present invention.

What is claimed is:

1. A mobile terminal for providing an advertisement based on a user circumstance, the mobile terminal comprising:
a user input unit for receiving user-input circumstance information;
a storage unit for storing the user-input circumstance information terminal-obtained circumstance information obtained by the mobile terminal, and user profile information;
a communication unit for receiving a customized advertisement information configured based on the user input circumstance information, the terminal-obtained circumstance information, the user profile information, and user movement prediction information;
a controller for predicting a movement of the user based on the user-input circumstance information, the terminal-obtained circumstance information, and the user profile information, providing the predicted movement of the user, and controlling output of a corresponding advertisement based on the received advertising information; and
a display unit for displaying the corresponding advertisement.

2. The mobile terminal of claim 1, wherein the user-input circumstance information includes at least one of a schedule of the user, an area to be visited by the user, a wish list, a residential area, item-to-be-purchased information, purchase history information, companion information, and interest information.

3. The mobile terminal of claim 1, wherein the terminal-obtained circumstance information includes time information, location information, weather information, and season information.

4. The mobile terminal of claim 1, wherein the controller determines whether the user circumstance corresponds to a time, a location, or a circumstance associated with the received customized advertisement information, and controls outputting of an advertisement corresponding to the time, the location, or the circumstance associated with the received advertising scenario.

5. The mobile terminal of claim 1, further comprising:
a customized advertisement information processing unit for configuring the advertising scenario based on the user-input circumstance information, the terminal-obtained circumstance information, and the user profile information.

6. The mobile terminal of one of claims 5, wherein the customized advertisement information is configured by arranging advertising information that matches the user profile information, the user input circumstance information, the terminal-obtained circumstance information, and the user location shift prediction information, based on a circumstance of the user, a time, or an order of a location shift associated with the user location shift prediction information.

7. A method of providing, by a terminal, an advertisement based on a user circumstance, the method comprising:
receiving an input of user-input circumstance information;
obtaining terminal-obtained circumstance information;
predicting a movement prediction information of a user based on the user-input circumstance information and the terminal-obtained circumstance information;
obtaining a customized advertisement information configured based on the user-input circumstance information, the terminal-obtained circumstance information, user location shift prediction information, and user profile information; and
outputting an advertisement based on the obtained customized advertisement information.

8. The method of claim 7, wherein the user-input circumstance information includes at least one of a schedule of the user, an area to be visited by the user, a wish list, a residential area, item-to-be-purchased information, purchase history information, companion information, and interest information.

9. The method of claim 7, wherein the terminal-obtained circumstance information includes time information, location information, weather information, and season information.

10. The method of claim 7, wherein outputting the advertisement based on the customized advertisement information comprises:
determining whether the user circumstance corresponds to a time, a location, or a circumstance associated with the customized advertisement information; and
displaying an advertisement corresponding to the time, the location, or the circumstance associated with the customized advertisement information.

11. The method of claim 7, further comprising:
configuring the customized advertisement information based on the user-input circumstance information, the terminal-obtained circumstance information, the user location shift prediction information, and the user profile information.

12. The method of one of claims 7, wherein the customized advertisement information is configured by arranging advertising information that matches the user profile information, the user input circumstance information, the terminal-obtained circumstance information, and the user location shift prediction information, based on a circumstance of the user, a time, or an order of a location shift associated with the user location shift prediction information.

13. An advertisement server for providing an advertisement to a mobile terminal based on a user circumstance, the advertisement server comprising:
a transceiving unit for receiving, from the mobile terminal, user-input circumstance information, terminal-obtained circumstance information, user location shift prediction information, and user profile information, and for transmitting a customized advertisement information;
an advertising information extracting unit for extracting at least one keyword associated with the user input circumstance information, the terminal-obtained circumstance information, the user location shift prediction information, and the user profile information, to receive a search result associated with the at least one keyword, and for extracting advertising information from an advertisement DataBase (DB);
a matching unit for matching the extracted advertising information to the user profile information, the user-input circumstance information, the terminal-obtained circumstance information, and the user location shift prediction information, through use of advertisement matching information stored in an advertisement matching DB, and for obtaining the advertising information according to the matching; and
a customized advertisement information configuring unit for configuring the customized advertisement information by arranging the obtained advertising information based on at least one of a circumstance, a time, and movement of a user.

14. A method of providing an advertisement to a mobile terminal based on a user circumstance, the method comprising:
receiving, from the mobile terminal, user-input circumstance information, terminal-obtained circumstance information, user location shift prediction information, and user profile information;
extracting at least one keyword associated with the user-input circumstance information, the terminal-obtained circumstance information, the user location shift prediction information, and the user profile information, receiving a search result associated with the at least one keyword, and extracting advertising information from an advertisement DataBase (DB);
matching the extracted advertising information to the user profile information, the user input circumstance information, the terminal-obtained circumstance information, and the user location shift prediction information, and obtaining matching advertising information according to the matching;
configuring the customized advertisement information by arranging the obtained advertising information, based on at least one of a circumstance, a time, movement of a user; and
transmitting the configured customized advertisement information.

15. A non-transitory computer-readable storage medium that stores a program implemented in a mobile terminal for performing a method for providing an advertisement based on a user circumstance, the method comprising:
receiving an input of user-input circumstance information;
obtaining terminal-obtained circumstance information;
predicting movement prediction information of a user based on the user-input circumstance information and the terminal-obtained circumstance information;
obtaining a customized advertisement information configured based on the user-input circumstance information, the terminal-obtained circumstance information, the user location shift prediction information, and user profile information; and
outputting an advertisement based on the obtained customized advertisement information.
